(19) United States
(12) Patent Application Publication
(10) Pub. No.: US 2011/0148755 A1
(43) Pub. Date: Jun. 23, 2011

(54) USER INTERFACE APPARATUS AND USER INTERFACING METHOD BASED ON WEARABLE COMPUTING ENVIRONMENT

(75) Inventors: Dong-Woo LEE, Daejeon (KR); Yong-Ki SON, Daejeon (KR); Jeong-Mook LIM, Daejeon (KR); Hyun-Tae JEONG, Daejeon (KR); Il-Yeon CHO, Daejeon (KR)

(73) Assignee: Electronics and Telecommunications Research Institute, Daejeon-city (KR)

(21) Appl. No.: 12/970,354

(22) Filed: Dec. 16, 2010

(30) Foreign Application Priority Data
Dec. 18, 2009 (KR) 10-2009-0127124

(51) Int. Cl. G09G 5/00

(52) U.S. Cl. 345/156

(57) ABSTRACT

Provided is a user interface apparatus based on wearable computing environment, which is worn on a user, including: a sensor unit including at least one sensor worn on the user and outputting a plurality of sensing signals according to a positional change of a user's arm or a motion of a user's finger; and a signal processing unit outputting a user command corresponding to the 3D coordinates of the user's arm and the motion of the user's finger from the plurality of sensing signals output from the sensor unit and, controlling an application program running in a target apparatus using the user command.

### CROSS REFERENCE TO RELATED APPLICATIONS

This application claims the benefit of Korean Patent Application No. 10-2009-0127124 filed on Dec. 18, 2009, which is hereby incorporated by reference in its entirety into this application.

### BACKGROUND OF THE INVENTION

1. Field of the Invention

The present invention relates to a user interface apparatus and method based on wearable computing environment, and more particularly, to a user interface apparatus and method based on wearable computing environment appropriate for wearable computing environment and is capable of using motions of both hands of a user in a 3D space in front of the user as an input of a wearable system or a peripheral device.

2. Description of the Related Art

There have been many attempts to detect motions of a user, particularly, motions of hands in a limited space equipped with a system and use the motions for interaction between humans and computers.

Existing systems have a drawback in that a user should wear a glove-shaped device or inputting is performed only in a well-equipped limited place.

Further, a device, such as a 3D space mouse or pen, on the market measures motions of user's hands by using a gyro sensor and uses the motions as user inputs. This device is inconvenient in that a user should hold it to use it and should carry it if necessary, and has a drawback in that smooth control using both hands is not easy since the relative positions of both hands cannot be known.

Multi-touch such as Apple's iPod Touch, Microsoft Surface, Jeff Han's multi-touch device is making the most of advantages of the multi-touch by applying touch to displays of devices; however, it is inconvenient in that it is necessary to hold a device with a hand or a screen should be within a distance where it is possible for a hand to reach.

Particularly, a user interface for a wearable system requiring that a device is attached to or worn on a body should be designed in consideration of factors such as mobility and wearability in order for a user to easily carry and use a device.

### SUMMARY OF THE INVENTION

The present invention has been made in an effort to provide a user interface apparatus based on wearable computing environment that is appropriate for wearable computing environment and can use motions of a user' hand in a 3D space in front of the user as inputs of a wearable system or a peripheral device being within a distance where the user's hands can't reach.

Further, the present invention has been made in an effort to provide a method for providing a user interface based on wearable computing environment.

An exemplary embodiment of the present invention provides a user interface apparatus based on wearable computing environment including: a sensor unit including at least one sensor worn on a user and outputting a plurality of sensing signals according to a positional change of a user's arm or a motion of a user's finger; and a signal processing unit outputting a user command corresponding to a 3D coordinates of the user's arm and the motion of the user's finger from the plurality of sensing signals output from the sensor unit and controlling an application program running in a target apparatus using the user command.

Another exemplary embodiment of the present invention provides a user interfacing method based on wearable computing environment including: sensing a positional change of a user's arm or a motion of a user's finger and outputting a first sensing signal and a second sensing signal; calculating 3D coordinates according to the current position of the user's arm from the first sensing signal; outputting a user command corresponding to the motion of the user's finger from the second sensing signal at the 3D coordinates; and controlling an application program running in a target apparatus according to the 3D coordinates and the user command.

According to the exemplary embodiments of the present invention, if a motion of both hands is made in a 3D space in front of a user, the motion is traced, and perceived as a specific 3D pattern and processed. Therefore, there is an advantage of supporting a user-friendly input interface just like a user handles an object in space in a method of selecting or operating an object on a user display by supporting a multi-point input function in a user space in wearable computing environment in which the user should use a computer while moving.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a drawing illustrating a user interface apparatus based on wearable computing environment according to an exemplary embodiment of the present invention;

FIG. 2 is a drawing illustrating various examples of the user interface apparatus of FIG. 1;

FIG. 3 is a schematic block diagram of a computing system including the user interface apparatus based on wearable computing environment shown in FIG. 1;

FIG. 4 is a schematic block diagram of an arm position detector shown in FIG. 3;

FIG. 5 is a schematic block diagram of a finger motion detector shown in FIG. 3;

FIG. 6 is a schematic block diagram illustrating a computing system including a user interface apparatus based on wearable computing environment according to another exemplary embodiment of the present invention; and

FIG. 7 is a flow chart illustrating the operation of a user interface apparatus based on wearable computing environment according to an exemplary embodiment of the present invention.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the exemplary embodiments of the present invention.

Hereinafter, the present invention will be described in detail by describing exemplary embodiments of the present invention with reference to the accompanying drawings. Like elements refer to like reference numerals shown in the drawings.

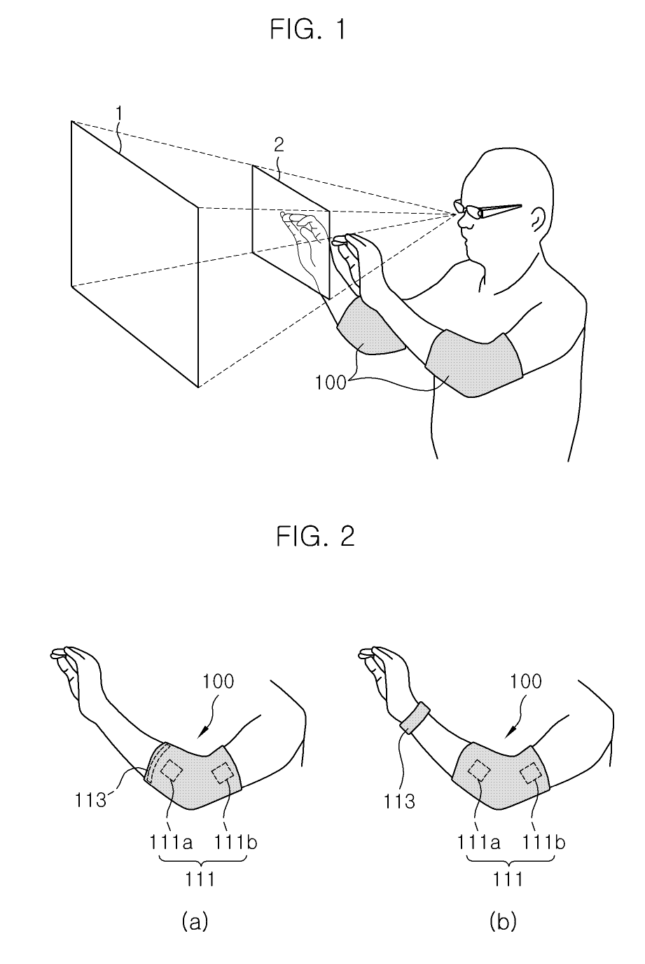

FIG. 1 is a drawing illustrating a user interface apparatus based on wearable computing environment according to an exemplary embodiment of the present invention, and FIG. 2 is a drawing illustrating various examples of the user interface apparatus of FIG. 1.

Referring to FIGS. 1 and 2, a user interface apparatus 100 based on wearable computing environment (hereinafter, referred to as a user interface apparatus) according to an exemplary embodiment of the present invention is worn on (or attached to) elbow areas of a user and can process positions and user commands according to motions of the user.

For example, as shown in FIG. 1, the user can move arms or fingers to control a real display screen 1 on a virtual display screen 2, not on the real display screen 1 such as a wall mounted display or an HMD (head mounted display) or an eye mounted display (EMD) of a wearable computer.

Here, the motions of the arms or fingers of the user correspond to all actions such as characters, symbols, and gestures, which the user can express, and may correspond to a complex action by both arms or both hands when user interface apparatuses 100 are worn on both arms of the user as shown in FIG. 1.

That is, the user can control an object in a 3D space output in front of eyes of the actual user similar to multi touch by inputting actions of the user with both arms or both hands on the virtual display screen 2.

Meanwhile, the user can also control the real display screen 1 by moving the arms or fingers of the user on the real display screen 1, not on the virtual display screen 2.

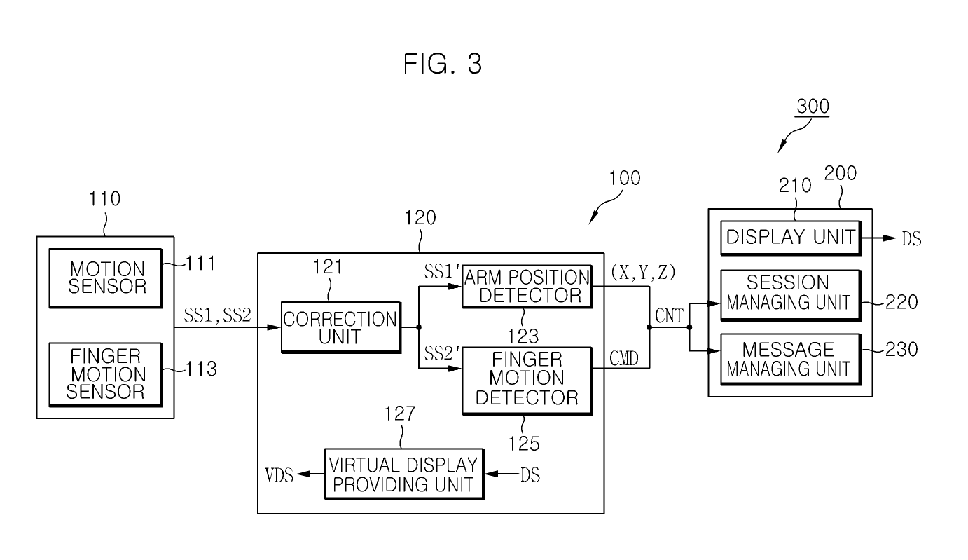

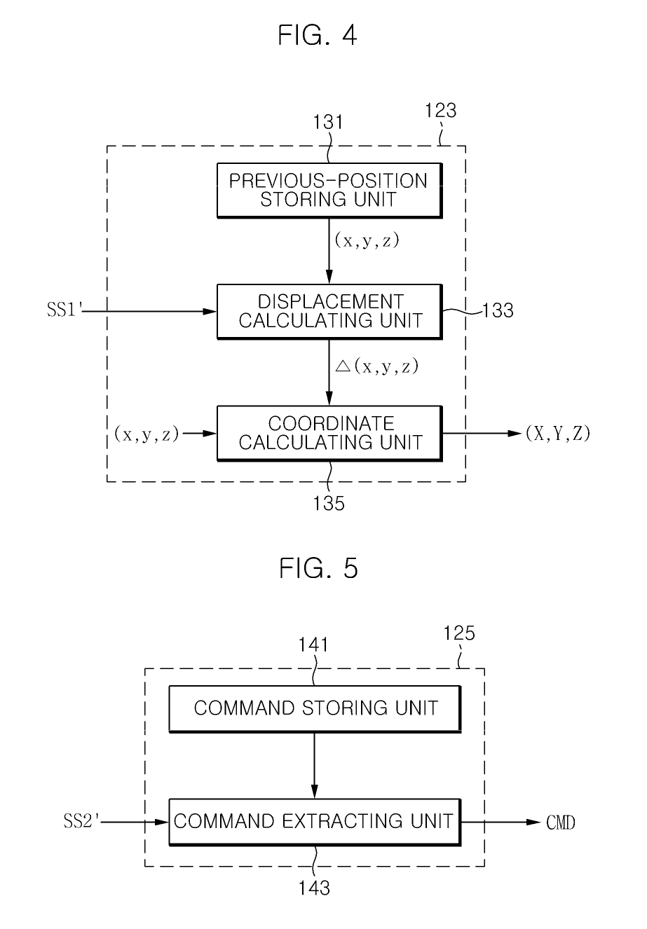

FIG. 3 is a schematic block diagram of a computing system including the user interface apparatus based on wearable computing environment shown in FIG. 1, FIG. 4 is a schematic block diagram of an arm position detector shown in FIG. 3, and FIG. 5 is a schematic block diagram of a finger motion detector shown in FIG. 3.

Hereinafter, the user interface apparatus will be described in detail with reference to FIGS. 3 to 5.

Referring to FIG. 3, a computing system 300 may include a user interface apparatus 100 and a target apparatus 200.

The user interface apparatus 100 may include a sensor unit 110 and a signal processing unit 120.

The sensor unit 110 may sense motions of the user as shown in FIGS. 1 and 2 and output sensing signals according to the motions, for example, a first sensing signal SS1 and a second sensing signal SS2.

The sensor unit 110 may include a motion sensor 111, for example, a first sensor for sensing motions (or positions) of arms of the user, and a finger motion sensor 113, for example, a second sensor for sensing motions (or gestures) of fingers of the user.

At least one motion sensor 111 may be positioned in the vicinities of elbows of the user as in (a) of FIG. 2, and may sense the positions or motions of the arms of the user and output a first sensing signal SS1.

The motion sensor 111 may include an upper sensor 111b positioned on an upper portion of an arm of the user, and a lower sensor 111a positioned on a lower position of the arm of the user.

This is for sensing not only left/right movements of the arm of the user but also up/down movements through the motion sensor 111.

The motion sensor 111 may be implemented by one or a combination of two or more of inertial sensors such as acceleration sensors, geomagnetic sensors, or gyro sensors.

The finger motion sensor 113 may sense motions of user's fingers and output the second sensing signal SS2.

The finger motion sensor 113 may be positioned to be adjacent to the motion sensor 111 as in (a) of FIG. 2 and may be positioned in a bracelet shape on a wrist as in (b) of FIG. 2.

Also, the finger motion sensor 113 may be positioned in a ring shape on a user's finger.

The finger motion sensor 113 may be implemented by one or a combination of two or more of electromyogram sensors, piezo-electric sensors, or optical signal sensors using optical signals.

The signal processing unit 120 may generate the coordinates (X, Y, Z) of the current position of the user and user commands CMD from the first sensing signal SS1 and the second sensing signal SS2 from the sensor unit 110 and output them.

The signal processing unit 120 may include a correction unit 121, an arm position detector 123, a finger motion detector 125, and a virtual display providing unit 127.

The correction unit 121 may correct the first sensing signal SS1 and the second sensing signal SS2 output from the sensor unit 110 and output a first corrected sensing signal SS1′ and a second corrected sensing signal SS2′.

For example, the correction unit 121 may prevent inaccuracy of sensing signals generated due to shaking of the user, for example, shaking of a user's arm or a user's hand, and for example, a filter may be used.

The arm position detector 123 may calculate the current position coordinates (X, Y, Z) according to a motion of the user's arm from the first corrected sensing signal SS1′ output from the correction unit 121.

Referring to FIGS. 3 and 4, the arm position detector 123 may include a previous-position storing unit 131, a displacement calculating unit 133, and a coordinate calculating unit 135.

There is stored in the previous-position storing unit 131 the previous position coordinates (x, y, z) of the user's arm at a previous time point, that is, at a time point immediately before the first sensing signal SS1 is output from the sensor unit 110.

If the first corrected sensing signal SS1′ from the correction unit 121 is input to the displacement calculating unit 133 of the arm position detector 123, the previous-position storing unit 131 may output the stored previous position coordinates (x, y, z) to the displacement calculating unit 133 and the coordinate calculating unit 135.

The displacement calculating unit 133 may output the position displacement Δ(x, y, z) of the user's arm by using the first corrected sensing signal SS1′ output from the correction unit 121 and the previous position coordinates (x, y, z) output from the previous-position storing unit 131.

The coordinate calculating unit 135 may output the current position coordinates (X, Y, Z) of the user's arm from the previous position coordinates (x, y, z) output from the previous-position storing unit 131 by using the position displacement 4(x, y, z) of the user's arm output from the displacement calculating unit 133.

Referring to FIGS. 3 and 5, the finger motion detector 125 may output a user command CMD according to a finger motion of the user from the second corrected sensing signal SS2′ output from the correction unit 121.

The finger motion detector 125 may include a command storing unit 141 and a command extracting unit 143.

A plurality of commands may be stored in the command storing unit 141. The plurality of commands may be mapped onto various individual finger motions of the user and the mapping relationships may be stored.

The plurality of commands may be programmed in advance by the user (or a developer) and stored in the command storing unit 141.

The command extracting unit 143 may extract one command corresponding to the second sensing signal, that is, the second corrected sensing signal SS2′ from among the plurality of commands stored in the command storing unit 141 according to the second corrected sensing signal SS2′ output from the correction unit 121.

The command extracting unit 143 may output the extracted one command as a user command CMD.

For example, if the user performs a movement to touch the virtual display screen (reference numeral 2 in FIG. 2) with a forefinger while wearing the user interface apparatus 100, the sensor unit 110 of the user interface apparatus 100 may sense that and output the second sensing signal SS2.

The finger motion detector 125 of the signal processing unit 120 may extract one command corresponding to screen touch from among the plurality of commands stored in the command storing unit 141 according to the second sensing signal SS2, and output the one command as the user command CMD.

Referring to FIG. 3 again, the signal processing unit 120 may merge the current position coordinates (X, Y, Z) of the user's arm output from the arm position detector 123 and the user command CMD output from the finger motion detector 125 and output the merged result as one control signal CNT.

The control signal CNT output from the signal processing unit 120 may be transmitted to the target apparatus 200 and control the operation of an application program being displayed in the target apparatus 200.

Further, although not shown in the drawing, the signal processing unit 120 may further include a wire/wireless communication unit (not shown), and transmit the generated control signal CNT to the target apparatus 200 by using wire or wireless communication.

The virtual display providing unit 127 of the signal processing unit 120 may generate the virtual display screen 2 from a screen transmitted from the target apparatus 200, that is, the real display screen 1, and output the virtual display screen 2 to the user.

The virtual display providing unit 127 may be an eye mounted display as shown in FIG. 1; however, it is not limited thereto.

That is, the user may control the virtual display screen 2 by doing various actions while watching the virtual display screen 2 provided from the virtual display providing unit 127 by using the eye mounted display, thereby controlling the real display screen 1 of the target apparatus 200.

Meanwhile, according to various exemplary embodiments of the present invention, the virtual display providing unit 127 may be omitted from the signal processing unit 120, and In this case, the user may control the target apparatus 200 while watching the real screen that the target apparatus 200 displays.

The target apparatus 200 may provide a display screen of an application program currently running to the user or the virtual display providing unit 127 of the signal processing unit 120, and control the application program according to the control signal CNT output from the user through the signal processing unit 120.

The target apparatus 200 may include a display unit 210, a session managing unit 220, and a message managing unit 230.

The display unit 210 may display an application program being running in the target apparatus 200. The display unit 210 may transmit a display screen DS to the user or the virtual display providing unit 127 of the signal processing unit 120.

The session managing unit 220 and the message managing unit 230 may control the application program being displayed in the display unit 210 according to the control signal CNT output from the signal processing unit 120.

For example, a plurality of users may wear user interface apparatuses 100, respectively. The session managing unit 220 and the message managing unit 230 of the target apparatus 200 may simultaneously control an application program running in the target apparatus 200 according to a plurality of control signals output from the user interface apparatuses 100 of the plurality of users.

That is, the session managing unit 220 may perform secession process on the control signals output from the plurality of users, respectively, and the message managing unit 230 may control the application program according to the plurality of control signals having been subject to the session process.

Accordingly, the plurality of users can cooperate while sharing the application program executed in the target apparatus 200 in real time.

Also, although not shown in the drawing, the target apparatus 200 may further include a gesture perceiving unit (not shown). The gesture perceiving unit may perceive gestures of the user from the continuous movement of the user and transmit the result to the application program running.

The user interface apparatus 100 according to an exemplary embodiment of the present invention has been described above in detail. The user interface apparatus 100 shown in FIGS. 1 to 5 may be implemented by the sensor unit 110 and the signal processing unit 120 connected thereto, and the user may control the application program executed in the target apparatus 200 while wearing the user interface apparatus 100.

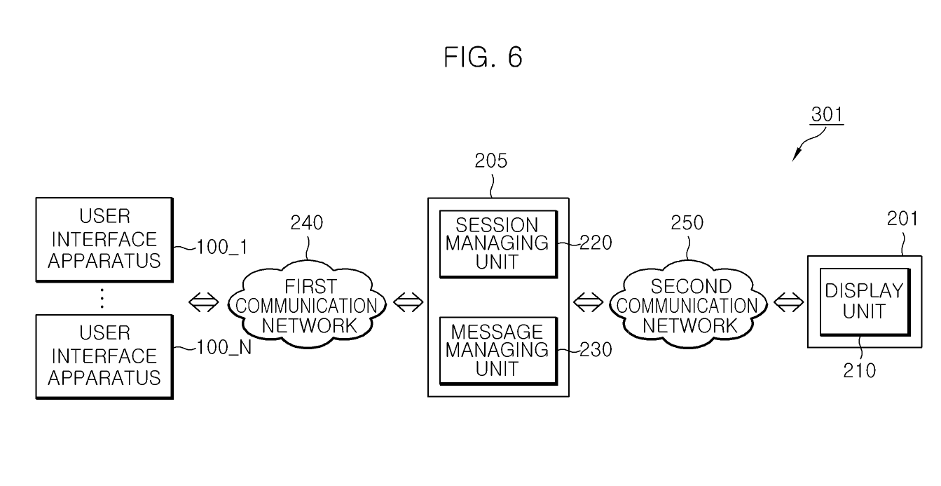

FIG. 6 is a schematic block diagram illustrating a computing system including a user interface apparatus based on wearable computing environment according to another exemplary embodiment of the present invention.

Hereinafter, a user interface apparatus 100′ according to another exemplary embodiment of the present invention will be described with reference to FIG. 6. For ease of explanation, members in FIG. 6 performing identical functions as members shown in FIGS. 1 to 5 are denoted by identical symbols, and a detailed description thereof is omitted.

Referring to FIGS. 3 to 6, a computing system 300 may include user interface apparatuses 100_1 to 100_N, a signal processing server 205, and a target apparatus 201.

The user interface apparatuses 100_1 to 100_N may be worn on the plurality of users, and each may have the same structure as described above with reference to FIGS. 3 to 5. Accordingly, a detailed description is omitted.

The signal processing server 205 may access the plurality of user interface apparatuses 100_1 to 100_N through a communication network, for example, a first communication network 240.

The signal processing server 205 may control a display of the target apparatus 201 by processing control signals CNT output from the individual user interface apparatuses 100_1 to 100_N.

That is, the signal processing server 205 may execute at least one application program and display the at least one application program to the plurality of users through the display unit 210 of the target apparatus 201.

The plurality of users may output the control signals CNT capable of controlling the application program(s) by using the plurality of user interface apparatuses 100_1 to 100_N while watching the display screen of the target apparatus 201 or virtual displays.

The signal processing server 205 may process the control signals CNT output from the individual user interface apparatuses 100_1 to 100_N at the same time (or sequentially) such that the plurality of users can cooperate.

The signal processing server 205 may include a session managing unit 220 and a message managing unit 230 which are the same as described above with reference to FIG. 3.

The target apparatus 201 may access the signal processing server 205 through a second communication network 250 and display the application program(s) controlled by the plurality of user interface apparatuses 100_1 to 100_N through the signal processing server 205 in real time.

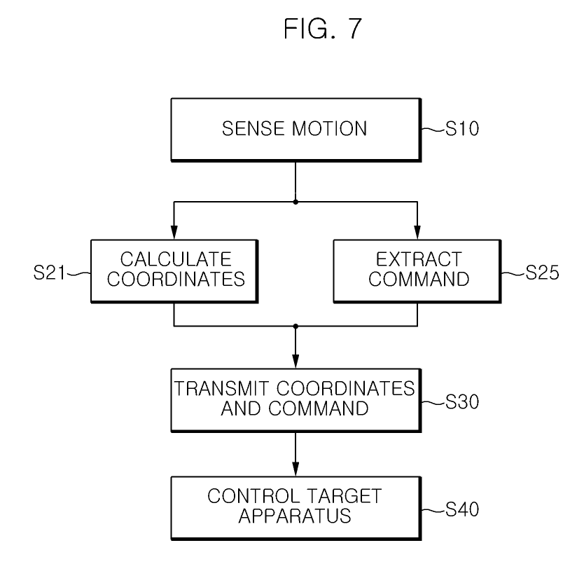

FIG. 7 is a flow chart illustrating the operation of a user interface apparatus based on wearable computing environment according to an exemplary embodiment of the present invention.

In exemplary embodiment, for ease of explanation, the operation of the user interface apparatus 100 shown in FIG. 3 will be described.

Referring to FIGS. 1, 3, and 7, the user may start control of the application program of the target apparatus 200 displayed on the virtual display screen 2 while wearing the user interface apparatus 100 on an arm (or both arms).

In this case, the user may do various actions such as moving the arm or a finger.

The sensor unit 110 of the user interface apparatus 100 may sense a motion of the user and output the first sensing signal SS1 and the second sensing signal SS2 (S10).

For example, the motion sensor 111 of the sensor unit 110 may sense a positional change of the user's arm and output the first sensing signal SS1.

Further, the finger motion sensor 113 of the sensor unit 110 may sense a motion of a user's finger and output the second sensing signal SS2.

Here, the user may move fingers in a state in which the arm is fixed and may move the arm in a state in which the fingers are fixed. In this case, the motion sensor 111 and the finger motion sensor 113 of the sensor unit 110 may also output the first sensing signal SS1 or the second sensing signal SS2 from one sensor.

If the first sensing signal SS1 is output from the sensor unit 110, the signal processing unit 120 may receive the first sensing signal SS1 and calculate the current position coordinates (X, Y, Z) of the user's arm (S21).

Further, if the second sensing signal SS2 is output from the sensor unit 110, the signal processing unit 120 may receive the second sensing signal SS2 and calculate the user command CMD (S25).

For example, the arm position detector 123 of the signal processing unit 120 may calculate the position displacement 4(x, y, z) of the user's arm from the first sensing signal SS1 and calculate the current position coordinates (X, Y, Z) of the user's arm from the previous position coordinates (x, y, z) of the user's arm by using the calculated position displacement Δ(x, y, z) of the user's arm.

Further, the finger motion detector 125 of the signal processing unit 120 may extract one command corresponding to the second sensing signal SS2 as the user command CMD from among the plurality of commands stored.

If the current position coordinates (X, Y, Z) of the user's arm is calculated and the user command CMD are extracted, the signal processing unit 120 may output them to the target apparatus 200 (S30).

For example, the signal processing unit 120 may merge the current position coordinates (X, Y, Z) of the user's arm and the user command CMD to generate one control signal CNT and transmit the generated control signal CNT to the target apparatus 200.

The target apparatus 200 may control the operation of the application program running according to the control signal CNT transmitted from the signal processing unit 120 (S40).

The user interface apparatus and method based on wearable computing environment applied to a wearable computer have been described above. However, it is apparent that the user interface apparatus and method based on wearable computing environment is usable as an interface apparatus of not only a wearable computer but also a general computer.

While the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A user interface apparatus based on wearable computing environment comprising:
a sensor unit including at least one sensor worn on a user and, outputting a plurality of sensing signals according to a positional change of a user's arm or a motion of a user's finger; and
a signal processing unit outputting a user command corresponding to a 3D coordinates of the user's arm and the motion of the user's finger from the plurality of sensing signals output from the sensor unit and, controlling an application program running in a target apparatus using the user command.

2. The user interface apparatus of claim 1, wherein:
the plurality of sensing signals include a first sensing signal and a second sensing signal, and the sensor unit includes:
at least one motion sensor disposed in the vicinity of an elbow and outputting a first sensing signal according to the positional change of the user's arm; and
a finger motion sensor disposed to be adjacent to the at least one motion sensor, sensing the motion of the user's finger, and outputting a second sensing signal.

3. The user interface apparatus of claim 2, wherein:
the at least one motion sensor is implemented by at least one of acceleration sensor, geomagnetic sensor, and gyro sensor.

4. The user interface apparatus of claim 2, wherein:
the finger motion sensor is implemented by at least one of electromyogram sensor, piezo-electric sensor, and optical signal sensor.

5. The user interface apparatus of claim 2, wherein:
the finger motion sensor is disposed on a wrist of the user.

6. The user interface apparatus of claim 1, wherein:
the sensor unit is worn on both arms and output the plurality of sensing signals according to positional changes of both arms and motions of fingers of both hands.

7. The user interface apparatus of claim 1, wherein:
the signal processing unit includes
a previous-position storing unit having a previous position coordinates of the user's arm stored therein; and
a coordinate calculating unit calculating a position displacement of the user's arm from the plurality of sensing signals and the previous position coordinates and, calculating the 3D coordinates according to the current position of the user's arm by using the position displacement.

8. The user interface apparatus of claim 7, wherein:
the signal processing unit further includes a correction unit correcting the plurality of sensing signals for correcting shaking of the user's arm or hand.

9. The user interface apparatus of claim 1, wherein:
the signal processing unit includes:
a command storing unit having a plurality of commands stored therein; and
a command extracting unit extracting one command from among the plurality of commands according to the plurality of sensing signals and, outputting the extracted one command as a user command.

10. The user interface apparatus of claim 1, wherein:
the user interface apparatus is worn on a plurality of users and
the plurality of users control the application program running in the target apparatus in cooperation with each other by using the user interface apparatus.

11. The user interface apparatus of claim 10, wherein:
the target apparatus includes a session managing unit and a message managing unit for controlling the application program according to the 3D coordinates and the user commands output from the individual user interface apparatuses of the plurality of users.

12. A user interfacing method based on wearable computing environment comprising:
sensing a positional change of a user's arm or a motion of a user's finger to output a first sensing signal and a second sensing signal;
calculating a 3D coordinates according to a current position of the user's arm from the first sensing signal;
outputting a user command corresponding to the motion of the user's finger from the second sensing signal at the 3D coordinates; and
controlling an application program running in a target apparatus according to the 3D coordinates and the user command.

13. The user interfacing method of claim 12, wherein:
the calculating of the 3D coordinates includes
calculating a position displacement of the user's arm according to the first sensing signal from the stored previous position coordinates of the user's arm; and
calculating the 3D coordinates according to the current position of the user's arm from the previous position coordinates by using the position displacement.

14. The user interfacing method of claim 13, wherein:
the calculating of the 3D coordinates further includes correcting the first sensing signal for correcting shaking of the user's arm.

15. The user interfacing method of claim 12, wherein:
the outputting the user command includes
extracting one command according to the second sensing signal from among the plurality of commands stored; and
outputting the extracted one command as the user command.

16. The user interfacing method of claim 12, wherein:
the sensing the positional change includes
sensing the position of the user's arm according to a movement and, outputting the first sensing signal; and
sensing the motion of the user's finger according to a movement and, outputting the second sensing signal.
